(19) United States
(12) Patent Application Publication
(10) Pub. No.: US 2021/0221732 A1
(43) Pub. Date: Jul. 22, 2021

(54) METHOD FOR PROCESSING GLASS CONTAINERS, CAPTURING DEVICE FOR CAPTURING AND HOLDING GLASS CONTAINERS AND APPARATUS FOR PROCESSING GLASS CONTAINERS

(71) Applicant: SCHOTT AG, Mainz (DE)

(72) Inventors: Michael Waschbüsch, Undenheim (DE); Hartmut Bauch, Mommenheim (DE); Oliver Fratzer, Egelsbach (DE); Andrea Anton, Hüffelsheim (DE); Hans-Joachim Schmitt, Ockenheim (DE)

(73) Assignee: SCHOTT AG, Mainz (DE)

(21) Appl. No.: 17/150,302

(22) Filed: Jan. 15, 2021

(30) Foreign Application Priority Data
Jan. 16, 2020 (DE) 20 2020 100 214.7

(51) Int. Cl. C03C 17/00; C03C 17/30; C03C 23/00

(52) U.S. Cl. CPC C03C 17/005; C03C 17/30; C03C 2218/111; C03C 2218/32; C03C 23/0075

(57) ABSTRACT

A method for processing of glass containers includes: simultaneously subjecting the glass containers to a first processing step; and simultaneously subjecting the glass containers to a second processing step after the first processing step. At least one of before or during at least one of the first processing step or the second processing step an outer container surface of each glass container is contact-free or in contact with a material having a lower hardness than that of the glass container or only in contact with such materials.

### CROSS REFERENCE TO RELATED APPLICATIONS

This application claims priority to German Patent Application No. DE 20 2020 100 214.7 filed on Jan. 16, 2020, which is incorporated in its entirety herein by reference.

### BACKGROUND OF THE INVENTION

### 1. Field of the Invention

The present invention relates to a method for processing glass containers, such as vials for pharmaceutical, medical or cosmetic applications, a device for capturing and holding such glass containers, and an apparatus for processing glass containers.

### 2. Description of the Related Art

Glass containers which are used as packaging material for pharmaceutical, medical or cosmetic applications are usually subjected to further processing steps after their hot forming before they are finally filled or distributed. Typical processing steps after hot forming are, for example, washing, followed by drying or sterilization to meet the high requirements, such as low particle load or sterility of the glass containers, for pharmaceutical, medical or cosmetic applications.

However, a drawback of known methods and devices for washing and drying or other processing of glass containers is that the glass containers usually suffer scratches or at least slightest damage to their surface through direct contact with their environment, such as system components or other glass containers, which might act as initial defects for breakage and can lead to a reduced strength of the glass containers. This problem occurs particularly when large quantities of glass containers are to be washed and dried or otherwise processed simultaneously in order to ensure a cost-efficient production, especially for packaging mass products. A further drawback of known methods is that unwanted substances can enter and contaminate the inside of the glass container during processing, which is undesirable in view of their pharmaceutical, medical or cosmetic use.

What is needed in the art is a method, apparatus and/or device for the processing of glass containers, which allows an efficient processing of glass containers and at the same time prevents damage to the glass surface in order to increase the strength of the containers on the one hand and to avoid cosmetic defects on the other hand as well as a method, apparatus and/or device for preventing the entry of substances into the interior of the glass container during the processing steps.

### SUMMARY OF THE INVENTION

In some exemplary embodiments provided according to the present invention, a method for processing a plurality of glass containers for pharmaceutical, medical or cosmetic applications is provided. The glass containers each include a hollow body surrounding an inner volume, having a lower end closed by a container bottom, a cylindrical container body, an upper end with a container shoulder, a container neck, a container collar, and a container opening which extends into the inner volume of the glass container, and an inner container surface facing the inner volume and an outer container surface facing away from the inner volume. The method includes: simultaneously subjecting the plurality of glass containers to a first processing step; and simultaneously subjecting the plurality of glass containers to a second processing step after the first processing step. At least one of before or during at least one of the first processing step or the second processing step the outer container surface of each glass container is contact-free or in contact with a material having a lower hardness than that of the glass container or only in contact with such materials.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 illustrates a schematic illustration of an apparatus for processing glass containers with several processing stations;

FIG. 2 illustrates a schematic illustration of an apparatus for processing glass containers with several processing stations and an air flow system;

FIG. 3 illustrates a schematic illustration of a capturing device with four capturing strips with seven holding sockets each;

FIG. 4A illustrates a schematic illustration of a capturing strip with a holding socket holding a glass container;

FIG. 4B illustrates another schematic illustration of a capturing strip with a holding socket holding a glass container;

FIG. 4C illustrates a schematic illustration of a glass container; and

FIG. 5 illustrates a schematic illustration of a glass container held by a holding socket, the container opening being sealingly closed by a sealing element.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

Exemplary embodiments provided according to the present invention provide a method related to the processing of glass containers, such as vials for pharmaceutical, medical or cosmetic applications, including: a hollow body surrounding an inner volume, having a lower end closed by a container bottom, a cylindrical container body, an upper end with a container shoulder, a container neck, a container collar and a container opening which extends into the inner volume of the glass container, and an inner container surface facing the inner volume and an outer container surface facing away from the inner volume.

The method includes that a plurality of glass containers is simultaneously subjected to a first processing step and thereafter the plurality of glass containers is simultaneously subjected to a second processing step. Before and/or during the first and/or second processing step the outer container surface of the glass container is contact-free or in contact with a material having a lower hardness than that of the glass container or only in contact with such materials.

In some embodiments, before and/or during the first and/or second processing step less than 20 percent of the outer container surface, such as less than 10 percent of the outer container surface, less than 5 percent of the outer container surface, or less than 2 percent of the outer container surface is in contact with a material, such as a material having a lower hardness than that of the glass container.

The part of the outer container surface that may come into contact with a material may be located at the upper end of the glass container, such as above the container shoulder and, for example, at the container neck and/or the container collar.

In some embodiments, the contact provided for holding the glass container is at its upper end, such as at its container collar and/or its container neck, such that the glass container is secured by the container collar against a downward movement.

In some embodiments, each glass container of the plurality of glass containers is held individually and without contact with respect to the other glass containers.

In some embodiments, the method further comprises that before and/or during the first and/or second processing step, the inner container surface of the glass container is contact-free, such as by sealingly closing the container opening of the glass containers in order to prevent substances from penetrating into the inner volume, to prevent penetration of liquids and solids into the inner volume, and also to prevent penetration of gases or gaseous compounds into the inner volume.

Furthermore, a third, a fourth and possibly even more processing steps may be included. Before and/or during the third, fourth and/or further processing steps, the outer container surface of the glass container is contact-free or in contact with a material having a lower hardness than that of the glass container or only in contact with such materials and, the inner container surface of the glass container may be contact-free, such as by sealingly closing the container opening of the glass containers in order to prevent substances from penetrating into the inner volume.

In some embodiments, in each processing step the plurality of glass containers is simultaneously processed, such as in an individual processing station.

In some embodiments, in each processing step the plurality of glass containers is simultaneously held by a capturing device, the capturing device being adapted to simultaneously capture and hold the plurality of glass containers.

For example, the method may comprise that the plurality of glass containers is simultaneously cleaned, such that the outside surface of the glass containers is cleaned with a cleaning fluid and/or the plurality of glass containers is simultaneously coated such that the outer container surface of the glass containers is coated with a coating material, the coating may be performed after the cleaning, the cleaning may be the first processing step, and the coating may be the second processing step. Before and/or during the cleaning and/or coating the outer container surface of the glass container is contact-free or in contact with a material having a lower hardness than that of the glass container or only in contact with such materials and, the inner container surface of the glass container is contact-free, such as by sealingly closing the container opening of the glass containers.

The cleaning of the glass containers may comprise ultrasonic cleaning.

The coating of the glass containers may be performed by dipping the glass container into a coating material. The coating material may comprise silicone or an emulsion with silicone and water, such as a silicone emulsion.

The coating material may, for example, be a silicone emulsion with a silicone content between 0.4 and 7 weight percent of the silicone emulsion or comprise such a silicone emulsion. In some embodiments, the coating material, such as the emulsion, also includes solvents, such as propylene glycol. The coating material, such as the silicone emulsion, may be formed such that it post-cures under the influence of temperature.

Due to the requirements for the pharmaceutical, medical or cosmetic application of coated glass containers, the coating material, such as the silicone, may be recommended by the German Federal Institute for Risk Assessment (BfR) for contact with foodstuffs and may be approved as a medical product by the German Federal Office for Drugs and Medical Devices (BfArM),

The coating material may, for example, comprise a 35% dimethicone emulsion. The coating material may also include water. Specifically, the coating material may comprise the Dow Corning® 365, 35% Dimethicone NF emulsion and/or the Dow Corning® 366 35% Dimethicone NF emulsion.

In some embodiments, the glass containers are first dipped with the container bottom into the coating material and then further up to an upper limit, such as at an upper edge of the glass containers. The upper limit may be located in the area of the container shoulder, such as in the transition area from the container shoulder to the cylindrical container body.

Furthermore, the glass containers may be removed again from the coating material. Subsequently, the coating may be homogenized, for example by removing or smoothing a drop of coating material formed at the container bottom. To this end, the plurality of glass containers, such as their outer container surface, for example the container bottom, may be dipped into a solvent or advanced to the surface of a solvent or advanced to a smoothing device.

The homogenization, which may occur after coating the glass containers, such as after removing the glass containers from the coating material, may be a further processing step in which the glass containers are simultaneously processed

In some embodiments, before and/or during the homogenization the outer container surface of the glass container is contact-free or in contact with a material having a lower hardness than that of the glass container or only in contact with such materials. In some embodiments, the inner container surface of the glass container is contact-free, such as by sealingly closing the container opening of the glass containers.

The method may further comprise drying the coating material, the drying may be a further processing step in which the glass containers are simultaneously processed. During the drying, the outer container surface of the glass container may be contact-free or in contact with a material having a lower hardness than that of the glass container or only in contact with such materials and the inner container surface of the glass container may be contact-free, such as by sealingly closing the container opening of the glass containers in order to prevent substances from penetrating into the inner volume.

The drying of the coating material may be performed by waiting and/or adding heat. The drying may also be performed by application of vacuum or microwave radiation.

The plurality of glass containers is simultaneously transported between the processing steps, such as by a transport device as described herein.

In some embodiments, the glass containers are transported such that the outer container surface of the glass container is contact-free or in contact with a material having a lower hardness than that of the glass container or only in contact with such materials and the inner container surface of the glass container is contact-free, such as by sealingly closing the container opening of the glass containers in order to prevent substances from penetrating into the inner volume.

In some embodiments, the transport device is adapted to move the capturing device from one processing station to the next processing station such that the plurality of glass containers held by the capturing device is simultaneously transported from one processing station to the next processing station.

The plurality of glass containers may be held during the processing steps and/or during the transporting such that each glass container is held individually and contact-free with respect to the other glass containers, and the container opening of the glass containers is sealingly closed, such as by the capturing device as described herein.

It may also be provided that the plurality of glass containers is held continuously during the processing steps and further held during transport. The container opening of the glass containers is sealingly closed meanwhile.

In some embodiments, an apparatus for processing, such as for cleaning and coating, glass containers, the apparatus comprising a capturing device, at least two processing stations and a transport device are also provided.

The glass containers, which are processed with the apparatus, may be configured as vials for pharmaceutical, medical or cosmetic applications, comprising a hollow body surrounding an inner volume, having a lower end closed by a container bottom, a cylindrical container body, an upper end with a container shoulder, a container neck, a container collar and a container opening which extends into the inner volume of the glass container, and an inner container surface facing the inner volume and an outer container surface facing away from the inner volume.

The capturing device of the apparatus is adapted to simultaneously capture and hold a plurality of glass containers. The capturing device comprises a plurality of individual holding sockets, each adapted to capture and hold one of the glass containers individually and contact-free with respect to the other glass containers.

The at least two processing stations of the apparatus are each adapted to simultaneously subject the plurality of glass containers held by the capturing device to a specific processing step.

Furthermore, the transport device of the apparatus is adapted to move the capturing device from one processing station to the next processing station such that the plurality of glass containers held by the capturing device is simultaneously transported from one processing station to the next processing station.

In some embodiments, the individual holding sockets of the capturing device are each designed to hold the glass container at its upper end, such as at its container collar and/or its container neck, in such a way that the glass container is secured by the container collar against downward movement, for example by the holding sockets clasping the container collar and/or the container neck.

For example, the individual holding sockets of the capturing device can each comprise a first and a second holding body, the two holding bodies being designed to be movable with respect to each other.

In some embodiments, the individual holding sockets of the capturing device are each designed to hold the glass container at its upper end, such as at its container collar and/or its container neck, in such a way that the glass container is secured against downward movement by the container collar, for example by the holding sockets clasping the container collar and/or the container neck.

For example, the individual holding sockets of the capturing device may each comprise a first and a second holding body, the two holding bodies being designed to be movable relative to each other.

In some embodiments, the two holding bodies are designed to be movable apart in such a way that a distance between the two holding bodies can be increased so that the two holding bodies of the holding socket can be placed over the container collar of the glass container from above. The distance can be increased to a limited extent so that the two holding bodies of the holding socket cannot be placed over the container bottom of the glass container from below.

In addition, the two holding bodies may be designed to be movable relative to each other in such a way that the distance between the two holding bodies is reducible again, so that the two holding bodies of the holding socket hold the glass container at its upper end, such as at its container collar and/or its container neck, for example by clasping it.

In some embodiments, the capturing device comprises one or more capturing strips, which each have a first strip arm and a second strip arm. The capturing strips each comprise at least some of the holding sockets, and the first strip arm of a capturing strip forms the first holding bodies of the holding sockets and the second strip arm forms the second holding bodies of the holding sockets.

In some embodiments, the capturing device comprises at least 2 holding sockets, such as at least 10 holding sockets, at least 25 holding sockets, at least 50 holding sockets, or at least 100 holding sockets.

The plurality of holding sockets of the capturing device can be arranged in a regular grid, for example a two-dimensional matrix, in such a way that the capturing device comprises a plurality of, for example, equidistantly arranged capturing strips each with a plurality of equidistantly arranged holding sockets.

For example, the capturing device may comprise at least 2 capturing strips each with at least 2 holding sockets, such as at least 3 capturing strips each with at least 3 holding sockets, at least 5 capturing strips each with at least 5 holding sockets, or at least 7 capturing strips each with at least 7 holding sockets.

In some embodiments, the capturing device has at least one sealing element which can be brought into sealing contact with the upper end of a glass container held by the capturing device, such as the container collar, in such a way that the container opening is sealed tightly in order to prevent the entry of substances into the inner volume during a processing step at one of the processing stations.

The at least one sealing element may be designed such that it can be brought simultaneously into sealing contact with the upper ends of several glass containers held by the capturing device in such a way that the container openings of all these glass containers are simultaneously sealed tightly.

Furthermore, the capturing device may comprise a pressing element adapted to press the upper end of the glass container held by the capturing device and the sealing element against each other in order to bring the upper end of the glass container into sealing contact with the sealing element.

The pressing element may be designed such that the upper end of the glass container is pressed against the sealing element, which may be fixedly attached to the capturing device, when the capturing device captures the glass container.

The pressing element can, for example, be designed as an edge of the first and/or second holding body being inclined with respect to the longitudinal axis of a glass container held by the capturing device.

The capturing device, such as its holding sockets, for example its holding body, may comprise a first contact area which comes into contact with the glass container during the capturing and holding of the glass container.

This first contact area can comprise or consist of a material which has a lower hardness than Shore D 95, such as a lower hardness than Shore D 90 or a lower hardness than Shore D 85. A hardness of at least Shore D 40 can be useful. In this respect, reference is made to ISO standard 7619-1. A hardness lower than Brinell 20 may also be used, wherein reference is made to ISO standards 6506-1 to 6506-4.

The first contact area may comprise or consist of a material recommended by the German Federal Institute for Risk Assessment (BfR) for contact with foodstuffs.

Furthermore, the first contact area may comprise or consist of one of the following materials: PU, PVC, rubber, silicone, fluorosilicone, PTFE or a similar material. The material can be a bulk material or a foam.

The sealing element may have a second contact area, which comes into contact with the glass container when capturing and holding the glass container.

This second contact area may include or consist of a material which is less hard than Shore A 75, such as less hard than Shore A 65.

Further, the second contact area may include or consist of a material recommended by the German Federal Institute for Risk Assessment (BfR) for contact with foodstuffs.

The second contact area may also include or consist of one of the following materials: PU, PVC, rubber, silicone, fluorosilicone, PTFE or a similar material. The material can be a bulk material or a foam.

The sealing element and the second contact area can at least partially consist of the same material, or consist of the same material.

In the following, some examples of possible processing stations of the apparatus provided according to the present invention are described.

Accordingly, the apparatus may comprise a processing station designed as a washing station for simultaneously washing the plurality of glass containers held by the capturing device in such a way that the outer container surface of the glass container is washed with a washing fluid, and in such a way that during this no washing fluid reaches the inner container surface of the glass container, and in such a way that the outer container surface of the glass container only comes into contact with materials which have a lower hardness than that of the glass container. Hardness of the glass container is understood to be the hardness of the glass material of the glass container. The hardness of any materials that may come into contact with the glass container is therefore lower than that of the glass material. To determine the hardness, the Mohs hardness can be used. In other words, it may be provided that the glass material can scratch the materials in contact with it.

Furthermore, the apparatus may comprise a processing station designed as a coating station for simultaneously coating the plurality of glass containers held by the capturing device in such a way that the outer container surface of the glass container is coated with a coating material, and in such a way that during this no coating material reaches the inner container surface of the glass container, and in such a way that the outer container surface of the glass container only comes into contact with materials which have a lower hardness than that of the glass container.

Furthermore, the apparatus may include a processing station designed as a homogenization station in order to simultaneously homogenize the coating on the plurality of glass containers held by the capturing device, such as, for example, smoothing and/or removing a drop of coating material formed at the container bottom, in such a way that the outer container surface of the glass container, such as the container bottom, is immersed in a solvent or is brought to the surface of a solvent, in such a way that in the process no solvent reaches the inner container surface of the glass container, and in such a way that the outer container surface of the glass container comes into contact only with materials which have a lower hardness than that of the glass container.

Alternatively, the processing station designed as a homogenization station can comprise at least one smoothing device, such as a plurality of smoothing devices corresponding to the plurality of glass containers, with the smoothing device designed as a pointed rod and/or consists of a material with a lower hardness than that of the glass container, in order to smooth and/or remove, such as simultaneously, on the plurality of glass containers held by the capturing device, a drop of coating material formed in each case on the container base, in such a way that the outer container surface of the glass container, for example the container bottom, is brought up to the smoothing device, and in such a way that the outer container surface of the glass container does not come into contact with the smoothing device.

Furthermore, the homogenization station can also include a suck-off device to homogenize the coating, e.g. to smooth and/or remove a drop of coating material formed at the container bottom. It is also possible that the homogenization station includes a device for moving the glass containers, such as a device for shaking and/or rotating the glass containers to achieve homogenization.

In addition, the apparatus may include a processing station designed as a drying station for simultaneously drying the plurality of glass containers held by the capturing device, in such a way that the outer container surface of the glass container comes into contact only with materials having a lower hardness than that of the glass container.

The capturing device of the apparatus may be arranged to hold the plurality of glass containers continuously during the processing steps to be carried out at the at least two processing stations and further during the transport from one processing station to the next processing station by the transport device.

In addition, the capturing device of the apparatus may be adapted to close the container opening of a glass container held by the capturing device by the sealing element continuously during the processing steps to be carried out at the at least two processing stations and further to close it during the transport from one processing station to the next processing station carried out by the transport device.

In order to ensure processing under clean room conditions, it may further be provided that the apparatus, such as the processing station designed as a washing station, the processing station designed as a coating station, the processing station designed as a homogenization station and/or the processing station designed as a drying station, comprises an air flow system for generating a laminar air flow.

Using the apparatus described previously, which comprises a washing station, a coating station and, if applicable, a homogenization station and, if applicable, a drying station, a process as disclosed previously can be carried out.

The present invention further relates to a capturing device for simultaneously capturing and holding a plurality of glass containers, such as vials for pharmaceutical, medical or cosmetic applications, which may be glass containers comprising a hollow body surrounding an inner volume, having a lower end closed by a container bottom, a cylindrical container body, an upper end with a container shoulder, a container neck, a container collar and a container opening which extends into the inner volume of the glass container, and an inner container surface facing the inner volume and an outer container surface facing away from the inner volume, such as for an apparatus for processing glass containers as described previously.

The capturing device comprises a plurality of individual holding sockets, each adapted to capture and hold one of the glass containers individually and contact-free with respect to the other glass containers.

In addition, the capturing device may include some or all of the features disclosed in connection with the capturing device of the apparatus described previously.

In some embodiments, the capturing device may be configured such that (a) the individual holding sockets of the capturing device each comprise a first and a second holding body, the two holding bodies being movable relative to each another, and (b) the capturing device comprises one or more capturing strips, each capturing strip comprising a first strip arm and a second strip arm, the first strip arm forming the first holding bodies of the holding sockets and the second strip arm forming the second holding bodies of the holding sockets, and (c) the capturing device comprises at least one sealing element which can be brought into sealing contact with the upper end of a glass container held by the capturing device, such as the container collar, such that the container opening is sealingly closed, and (d) the capturing device comprises a pressing element adapted to press the upper end of the glass container held by the capturing device and the sealing element against each other to bring the upper end of the glass container into sealing contact with the sealing element.

Alternatively, the capturing device may, for example, also be configured as a suction device. In this case, the plurality of individual holding sockets may each be designed as suction ports, which may each be configured to capture and hold one of the glass containers individually and without contact to the other glass containers.

To this end, a suction port may comprise a suction seal and a suction inlet, the suction seal enclosing the suction inlet and the suction inlet being configured to generate a negative pressure relative to the environment.

The suction seal may be configured for establishing sealing contact with the upper end of the glass container, such as the container collar.

The suction inlet may be configured to generate a vacuum through the container opening within the inner volume of the container when the suction seal is in sealing contact with the upper end of the container, in order to capture and hold the glass container by the vacuum in its interior.

The capturing device being configured as a suction device as described previously may also be employed as a capturing device within the apparatus described previously.

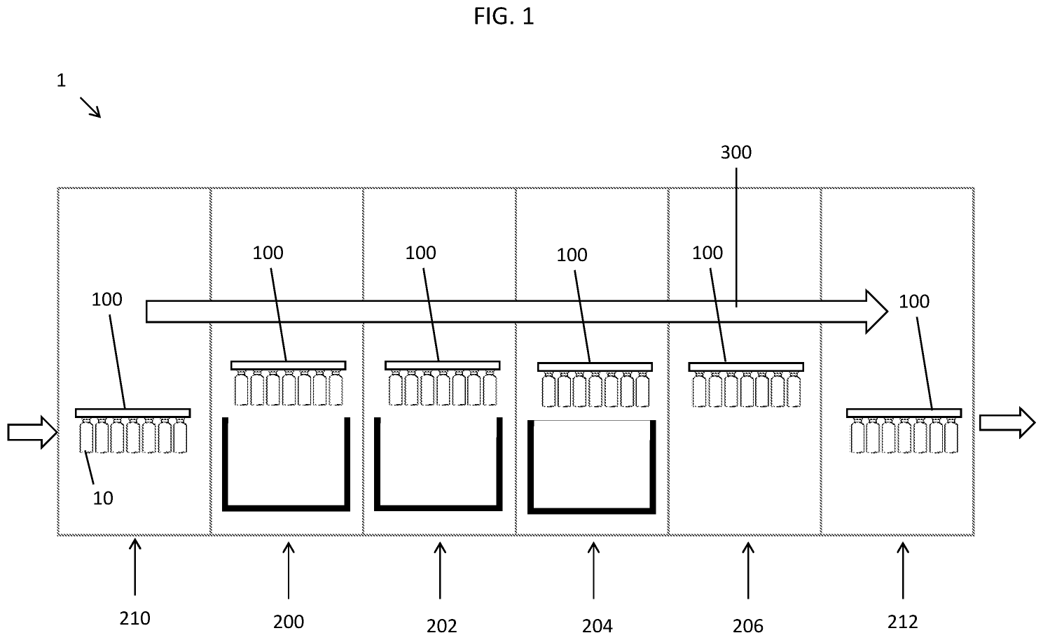

Referring now to the drawings, FIG. 1 shows an apparatus 1 allowing a plurality of glass containers 10 after hot forming to be simultaneously subjected to different processing steps in order to prepare the glass containers 10 for pharmaceutical, medical or cosmetic applications.

The apparatus 1 comprises a feeder 210 in which the plurality of glass containers 10 can be inserted manually or automatically. The feeder 210 can also be designed to receive a transport packaging (e.g. ready-to-use packaging), also known as a tub or tray, for a plurality of glass containers 10 arranged regularly and spaced from each other. After the glass containers 10 are inserted into the feeder 210, they are collected for further processing.

For this purpose, the apparatus 1 comprises a capturing device 100, which can, for example, be designed so that it can be moved downwards in order to capture the glass containers 10 inserted into the feeder 210 at their upper ends 15. The capturing device 100 is designed such that the glass containers 10 are captured with mutual spacing so that mutual contact of the glass containers 10 is avoided.

The capturing device 100 can be designed to be movable in an upwards direction as well so that the plurality of glass containers 10 are still held by the capturing device 100 at their upper ends 15 and can be subjected to further processing steps in this state. To carry out these processing steps, apparatus 1 comprises several processing stations, in this example a washing station 200, a coating station 202, a homogenization station 204 and a drying station 206.

In order to transport the plurality of glass containers 10 held by the capturing device 100 to these processing stations 200, 202, 204, 206, the apparatus 1 also comprises a transport device 300, which is designed to move the capturing device 100 with the glass containers 10 first from the feeder 210 to the first processing station, here designed as washing station 200, and then one after another to the further processing stations.

The apparatus 1 shown here also includes an outlet 212 to discharge the glass containers 10 from the apparatus 1 after their processing. Consequently, the capturing device 100 is also designed to release the glass containers 10, such as after their processing. The transport device 300 can be designed as a rotary conveyor which moves the capturing device 100 after the last processing station 206 or after the outlet 212 back to the starting position, e.g. the feeder 210.

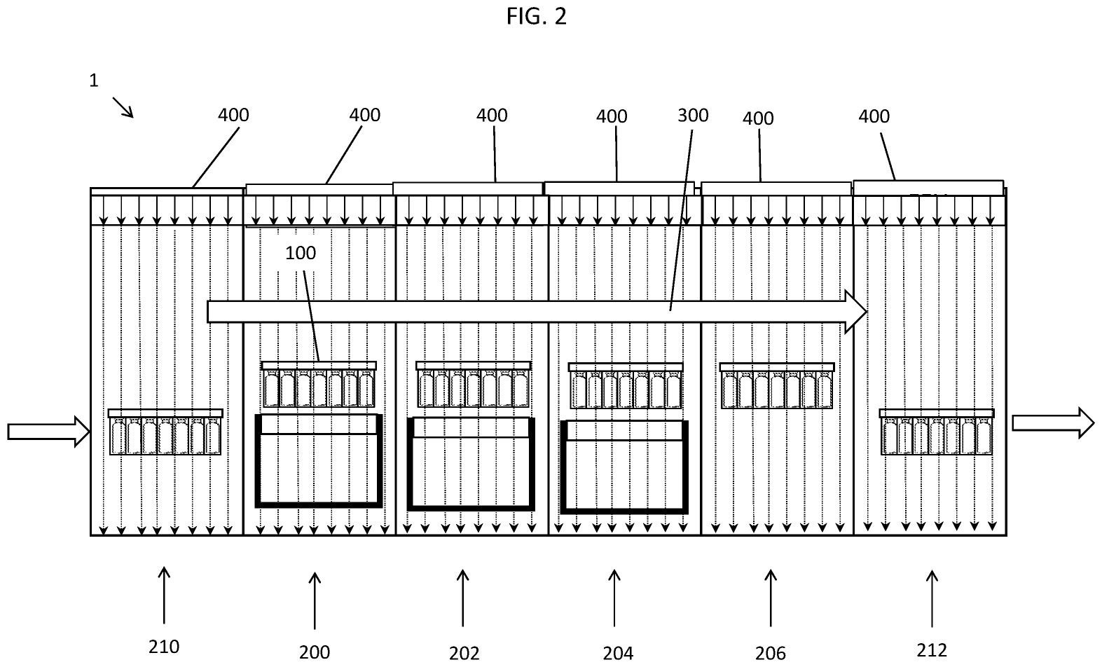

FIG. 2 shows another apparatus 1 for processing a plurality of glass containers 10 The apparatus corresponds to the apparatus 1 shown in FIG. 1, but is additionally equipped with an air flow system 400, which in this example comprises several units for each of the processing stations 200, 202, 204, 206 and the feeder 210 and the outlet 212. With the airflow system 400, air can be blown in from above the apparatus 1 into the apparatus 1 or in the individual processing stations, for example via a filter, and extracted again below the apparatus.

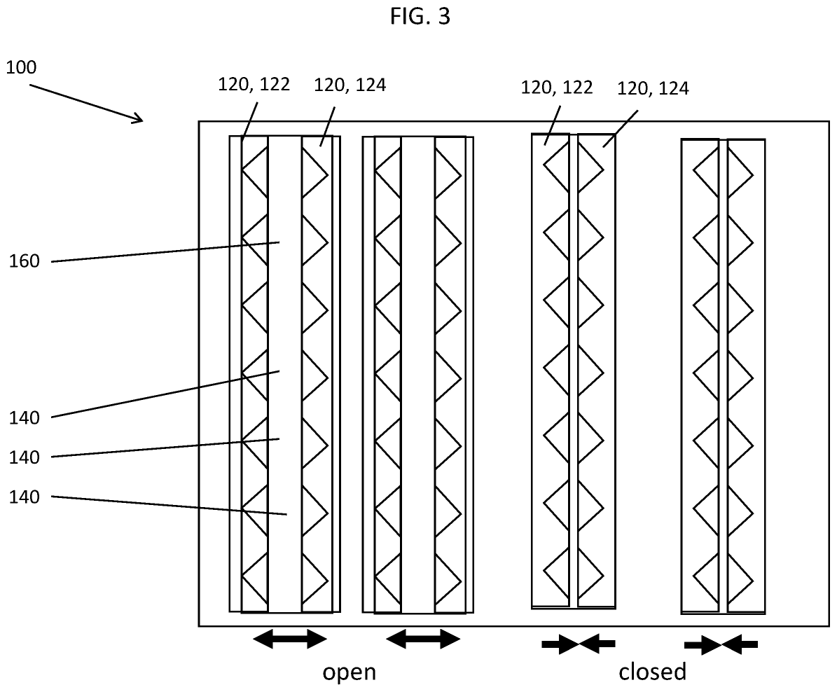

FIG. 3 shows the capturing device 100 in a top view. The capturing device 100 comprises a plurality of individual holding sockets 140, each of which is designed to capture, hold, and release one of the glass containers 10 individually and without contact to the other glass containers 10. Furthermore, the capturing device 100 comprises several capturing strips 120 arranged side by side in a first dimension. Each of the capturing strips 120 in turn comprises several of the holding sockets 140, which are arranged side by side in a second dimension.

The adjacent capturing strips 120 each comprise two strip arms 122, 124. The two strip arms 122, 124 are designed to be movable with respect to each other such that the two strip arms 122, 124 can be moved away from each other to set the holding sockets 140 in an open state and can be moved towards each other to set the holding sockets 140 in a closed state.

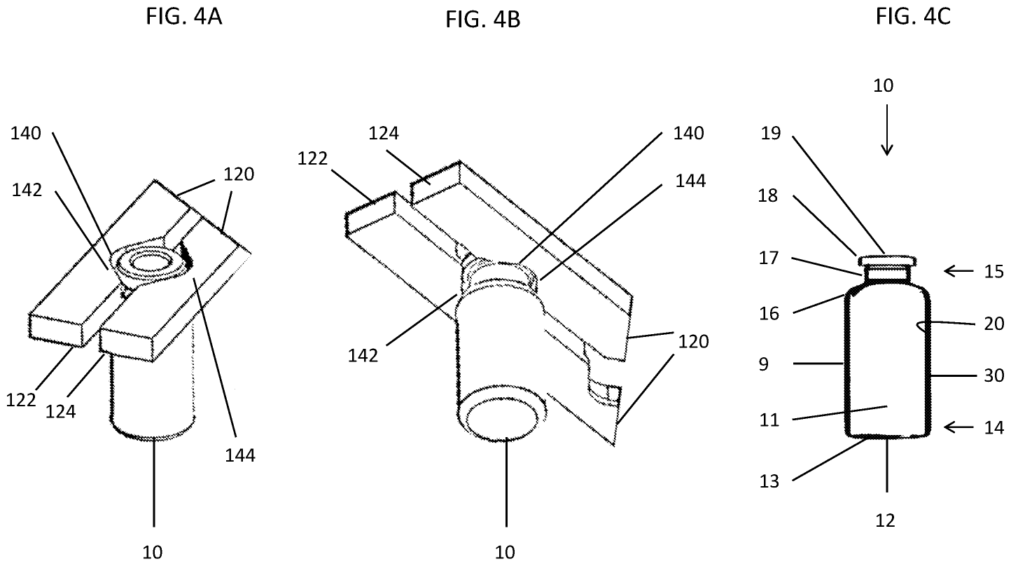

FIGS. 4A and 4B show a part of a capturing strip 120 with the two opposed strip arms 122, 124. The two strip arms 122, 124 form a holding socket 140 adapted to the shape of the container neck 17 and/or container collar 18, with a first and second holding body 142, 144. The first holding body 142 can be formed by an essentially semicircular recess in the first strip arm 122, while the second holding body 144 can be formed by an opposite, again essentially semicircular recess in the second strip arm 124, such that the two semicircular recesses together define an essentially circular holding socket 140 for gripping the container neck 17 and/or the container collar 18.

The two strip arms 122, 124 of the capturing strip 120 can be moved away from each other in order to move the two holding bodies 142, 144 apart and thus open the holding socket 140. When the holding socket 140 is in the open state, the capturing strip 120 with the holding socket 140 designed as a recess can be moved from above over the container collar 18 of the glass container 10. Furthermore, the two strip arms 122, 124 of the capturing strip 120 can be moved towards each other again in order to move the two holding bodies 142, 144 towards each other and thus close the holding socket 140.

FIG. 4C shows an example of a glass container 10 designed as a vial for pharmaceutical, medical or cosmetic applications, which can be processed with the described apparatus 1. The glass container 10 comprises a hollow body 12 surrounding an inner volume 11 with a lower end 14 closed by a container bottom 13, a cylindrical container body 9, an upper end 15 with a container shoulder 16, a container neck 17, a container collar 18 and a container opening 19 which extends into the inner volume 11 of the glass container 10, as well as an inner container surface 20 facing the inner volume 11 and an outer container surface 30 facing away from the inner volume 11.

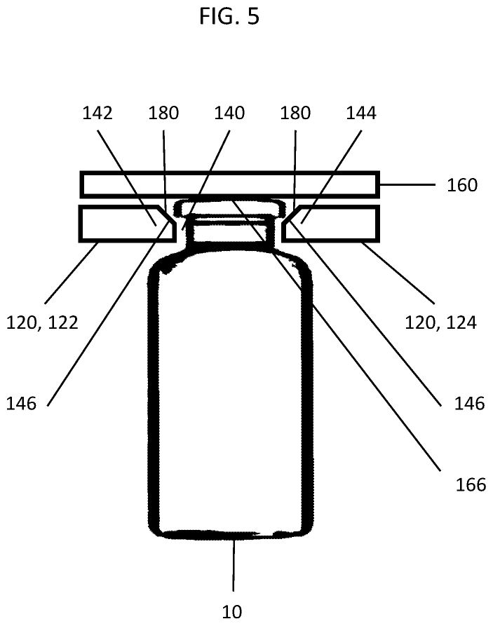

FIG. 5 shows a glass container 10 held by a holding socket 140 in the closed state. The two holding bodies 142, 144 are designed to engage under the container collar 18 such that the glass container is secured against a downward movement. A sealing element 160 is arranged above the capturing strip 120, which seals the upper end 15 of the glass container when the holding socket 140 is closed. For this purpose, the holding bodies 142, 144 comprise a pressing element 180, which is designed as an edge of the holding bodies 142, 144 inclined to the longitudinal axis of the glass container 10 in order to press the glass container 10 upwards against the sealing element.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for processing a plurality of glass containers for pharmaceutical, medical or cosmetic applications, the glass containers each comprising a hollow body surrounding an inner volume, having a lower end closed by a container bottom, a cylindrical container body, an upper end with a container shoulder, a container neck, a container collar, and a container opening which extends into the inner volume of the glass container, and an inner container surface facing the inner volume and an outer container surface facing away from the inner volume, the method comprising:
simultaneously subjecting the plurality of glass containers to a first processing step; and
simultaneously subjecting the plurality of glass containers to a second processing step after the first processing step, wherein at least one of before or during at least one of the first processing step or the second processing step the outer container surface of each glass container is contact-free or in contact with a material having a lower hardness than that of the glass container or only in contact with such materials.

2. The method for processing the glass containers of claim 1, wherein at least one of before or during at least one of the first processing step or the second processing step less than 20 percent of the outer container surface is in contact with a material having a lower hardness than that of the glass container.

3. The method for processing the glass containers of claim 1, wherein at least one of:
a part of the outer container surface of the glass container being in contact with the material is located at the upper end of the glass container;
the contact provides for holding the glass container; or
each glass container of the plurality of glass containers is held individually and without contact with respect to the other glass containers.

4. The method for processing the glass containers of claim 3, wherein the part of the outer container surface of the glass container in contact with the material is above the container shoulder.

5. The method for processing the glass containers of claim 1, wherein at least one of before or during at least one of the first processing step or the second processing step, the inner container surface of the glass container is contact-free.

6. The method for processing the glass containers of claim 5, wherein at least one of before or during at least one of the first processing step or the second processing step the container opening of the glass containers is sealingly closed in order to prevent substances from penetrating into the inner volume.

7. The method for processing the glass containers of claim 1, further comprising a third processing step, wherein at least one of:
at least one of before or during the third processing step, the outer container surface of the glass container is contact-free or in contact with a material having a lower hardness than that of the glass container or only in contact with such materials;
in each of the processing steps the plurality of glass containers is simultaneously processed; or
in each of the processing steps the plurality of glass containers is simultaneously held by a capturing device.

8. The method for processing the glass containers of claim 1, wherein the plurality of glass containers is at least one of simultaneously cleaned such that the outside surface of the glass containers is cleaned with a cleaning fluid or simultaneously coated such that the outer container surface of the glass containers is coated with a coating material; and
at least one of before or during at least one of the cleaning or the coating the outer container surface of the glass container is contact-free or in contact with a material having a lower hardness than that of the glass container or only in contact with such materials.

9. The method for processing the glass containers of claim 8, wherein the cleaning is the first processing step and the coating is the second processing step.

10. The method for processing the glass containers of claim 8, wherein at least one of:
the cleaning of the glass containers comprises ultrasonic cleaning; or
the coating of glass containers comprises dipping the glass container into the coating material.

11. The method for processing the glass containers of claim 10, wherein the coating of the glass containers comprises dipping the glass containers first with the container bottom into the coating material and then further up to an upper limit.

12. The method for processing the glass containers of claim 11, wherein the upper limit is located in an area of the container shoulder.

13. The method for processing the glass containers of claim 8, wherein the coating material has one or more of the following properties:
(a) the coating material is a silicone emulsion with a silicone content between 0.4 and 7 percent by weight of the silicone emulsion or comprises such a silicone emulsion;
(b) the coating material also includes solvents;
(c) the coating material is formed such that it post-cures under the influence of temperature;
(d) the coating material at least one of is recommended by the German Federal Institute for Risk Assessment (BfR) for contact with foodstuffs and is approved as a medical product by the German Federal Office for Drugs and Medical Devices (BfArM);
(e) the coating material comprises a 35% dimethicone emulsion; or
(f) the coating material comprises a 35% dimethicone NF emulsion.

14. The method for processing the glass containers of claim 8, wherein after coating the glass containers, the coating is homogenized by removing or smoothing a drop of coating material formed at the container bottom, at least one of before or during the homogenization the outer container surface of the glass container is contact-free or in contact with a material having a lower hardness than that of the glass container or only in contact with such materials, and when homogenizing the coating, the plurality of glass containers is dipped into a solvent or advanced to a surface of a solvent or advanced to a smoothing device.

15. The method for processing the glass containers of claim 14, wherein at least one of:
at least one of before or during the homogenization the inner container surface of the glass container is contact-free; or
at least one of before or during the homogenization the container opening of the glass containers is sealingly closed in order to prevent substances from penetrating into the inner volume.

16. The method for processing the glass containers of claim 8, further comprising drying the coating material, wherein during the drying the outer container surface of the glass container is contact-free or in contact with a material having a lower hardness than that of the glass container or only in contact with such materials, and at least one of:
the drying of the coating material comprises at least one of waiting or adding heat; or
the drying is carried out under application of vacuum or microwave radiation.

17. The method for processing the glass containers of claim 16, wherein at least one of:
during the drying the outer container surface of the glass container the inner container surface of the glass container is contact-free; or
during the drying the container opening of the glass containers is sealingly closed in order to prevent substances from penetrating into the inner volume.

18. The method for processing the glass containers of claim 1, wherein the plurality of glass containers is simultaneously transported between the processing steps and the glass containers are transported such that the outer container surface of the glass container is contact-free or in contact with a material having a lower hardness than that of the glass container or only in contact with such materials.

19. The method for processing the glass containers of claim 18, wherein at least one of:
the glass containers are transported such that the inner container surface of the glass container is contact-free; or
during transport the container opening of the glass containers is sealingly closed in order to prevent substances from penetrating into the inner volume.

20. The method for processing the glass containers of claim 18, wherein at least one of:
at least one of during the processing steps or during the transporting, the plurality of glass containers is held such that each glass container is held individually and contact-free with respect to the other glass containers by a capturing device and the container opening of each glass containers is sealingly closed by the capturing device; or
the plurality of glass containers is held continuously during the processing steps and further held during transport and the container opening of each glass container is sealingly closed meanwhile.
